(19) United States
(12) Patent Application Publication
(10) Pub. No.: US 2007/0120774 A1
(43) Pub. Date: May 31, 2007

(54) Plasma display, driving device, and driving method

(76) Inventors: Joon-Yeon Kim, Yongin-si (KR); Hak-Cheol Yang, Yongin-si (KR); Sang-Shin Kwak, Yongin-si (KR); Jong-Ki Choi, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/605,903

(22) Filed: Nov. 29, 2006

(30) Foreign Application Priority Data
Nov. 30, 2005 (KR) 10-2005-0115854
Nov. 30, 2005 (KR) 10-2005-0115860

(51) Int. Cl. G09G 3/28

(52) U.S. Cl. 345/68

(57) ABSTRACT

A plasma display according to an embodiment of the present invention has first, second, and third transistors which are coupled between a first power source for supplying a first voltage and a second power source for supplying a second voltage which is lower than the first voltage is disclosed. A first terminal of a fourth transistor is coupled to the first and second transistors, and a first terminal of a fifth transistor is coupled to the second and third transistors. In addition, a capacitor is coupled between a second terminal of the fourth transistor and a second terminal of the fifth transistor and is charged with a voltage corresponding to a difference between the first and second voltages.

### CROSS-REFERENCE TO RELATED APPLICATIONS

This application claims priority to and the benefit of Korean Patent Applications No. 10-2005-0115854 filed on Nov. 30, 2005, and No. 10-2005-0115860 filed on Nov. 30, 2005, in the Korean Intellectual Property Office, the entire contents of which are incorporated herein by reference.

### BACKGROUND OF THE INVENTION

1. Field of the Invention

The present invention relates to a plasma display, a driving apparatus and a driving method thereof.

2. Description of the Related Technology

A plasma display is a flat panel display that uses plasma generated by a gas discharge process to display characters or images. It includes, depending on its size, more than several scores to millions of pixels arranged in a matrix pattern.

On a panel of the plasma display, a field (e.g., 1 TV field) is divided into a plurality of subfields respectively having a weight. Gray scales are expressed by a combination of weights of subfields at which a display operation is generated from among the subfields. Each subfield has an address period in which an address operation for selecting discharge cells to emit light and discharge cells to emit no light from among a plurality of discharge cells is performed, and a sustain period in which a sustain discharge occurs in the selected discharge cells to perform a display operation during a period corresponding to a weight of a subfield.

Particularly, since a high level voltage and a low level voltage are alternately applied to an electrode for performing the sustain discharge during the sustain period, a transistor for applying the high and low voltages is required to have an internal voltage corresponding to a difference between the high and low voltages. Accordingly, because of the transistor having the high internal voltage, a cost of a sustain discharge driving circuit is increased.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

Certain inventive aspects provide a plasma display using a transistor having a low voltage in a sustain discharge driving circuit, and a driving device and method thereof.

One embodiment is a plasma display including a plurality of first electrodes, a first transistor having a first terminal coupled to a first power source, the first power source configured to supply a first voltage, a second transistor having a first terminal coupled to a second terminal of the first transistor, a third transistor having a first terminal coupled to a second terminal of the second transistor and a second terminal coupled to a second power source, the second power source configured to supply a second voltage, the second voltage being lower than the first voltage, a fourth transistor having a first terminal coupled to the second terminal of the first transistor, a fifth transistor having a first terminal coupled to the second terminal of the second transistor, a charging power source coupled to a second terminal of the fourth transistor and a second terminal of the fifth transistor, a sixth transistor coupled to the second terminal of the fourth transistor, and coupled to one or more of the plurality of first electrodes, a seventh transistor coupled to the second terminal of the fifth transistor, and coupled to one or more of the plurality of first electrodes, an inductor having a first terminal coupled to the sixth transistor and to the seventh transistor, and a path separating unit including a first node selectively coupled to one of the charging power source and a third power source configured to supply a third voltage, a second node coupled to a second terminal of the inductor, first and second current paths, where the first current path conducts current from the first node to the second node, and the second current path conducts current from the second node to the first node, where the first node is coupled to the charging power source when a voltage at the one or more of the plurality of first electrodes is substantially stable, and the first node is coupled to the third power source when the voltage at the one or more of the plurality of first electrodes is changing.

Another embodiment is a method of driving a plasma display including a plurality of first electrodes. The driving method includes applying a third voltage to the plurality of first electrodes with a first power source configured to supply a first voltage and a capacitor charged with a second voltage, increasing a voltage at the plurality of first electrodes through a first resonance path, the path including a first inductor and a second power source configured to supply a fourth voltage, the fourth voltage being higher than the first voltage, applying a sixth voltage to the plurality of first electrodes with the capacitor and a third power source configured to supply a fifth voltage, the fifth voltage being higher than the fourth voltage, and decreasing the voltage at the plurality of first electrodes with a second resonance path including the second power source and a second inductor.

Another embodiment is a driving method for driving a plasma display including a plurality of first electrodes. The driving method includes applying a third voltage to the plurality of first electrodes with a first power source configured to supply a first voltage, and first and second capacitors each charged with a second voltage, increasing a voltage at the plurality of first electrodes through a first resonance path, the path including the first power source, the first capacitor, and a first inductor, further increasing the voltage at the plurality of first electrodes through a second resonance path including the first power source, the second capacitor, and the first inductor, further increasing the voltage at the plurality of first electrodes through a third resonance path including a second power source, the second capacitor, and the first inductor, applying a fourth voltage to the plurality of first electrodes with the second power source, the first capacitor, and the second capacitor, decreasing the voltage at the plurality of first electrodes through a fourth resonance path including the second inductor, the second capacitor, and the second power source, further decreasing the voltage at the plurality of first electrodes through a fifth resonance path including the second inductor, the second capacitor, and the first power source, and further decreasing the voltage at the plurality of first electrodes through a sixth resonance path including the second inductor, the first capacitor, and the first power source.

Another embodiment is a driving device configured to drive a plasma display including a plurality of first electrodes. The driving device includes a first transistor having a first terminal coupled to a first power source, the first power source configured to supply a first voltage, a second transistor having a first terminal coupled to a second terminal of the first transistor, a third transistor having a first terminal coupled to a second terminal of the second transistor and a second terminal coupled to a second power source, the second power source configured to supply a second voltage, the second voltage being lower than the first voltage, a fourth transistor having a first terminal coupled to the second terminal of the first transistor, a fifth transistor having a first terminal coupled to the second terminal of the second transistor, a charging power source coupled to a second terminal of the fourth transistor and a second terminal of the fifth transistor, a sixth transistor coupled to one or more of the plurality of first electrodes and the second terminal of the fourth transistor, a seventh transistor coupled to one or more of the plurality of first electrodes and the second terminal of the fifth transistor, and an inductor having a first terminal coupled to the sixth transistor and the seventh transistor, and a path separating unit including a first node selectively coupled to one of the charging power source and a third power source configured to supply a third voltage, a second node coupled to a second terminal of the inductor, first and second current paths, where the first current path conducts current from the first node to the second node, and the second current path conducts current from the second node to the first node, where the first node is coupled to the charging power source when a voltage at the one or more of the plurality of first electrodes is substantially stable, and the first node is coupled to the third power source when the voltage at the one or more of the plurality of first electrodes is changing.

### BRIEF DESCRIPTION OF THE DRAWINGS

FIG. 1 shows a diagram representing a plasma display according to an embodiment.

FIG. 2 to FIG. 4 respectively show driving waveforms of the plasma display device according to some embodiments.

FIG. 5 shows a diagram of a sustain discharge driving circuit of a scan electrode driver according to some embodiments.

FIG. 6 shows a signal timing diagram of the sustain discharge driving circuit according to some embodiments.

FIG. 7A to FIG. 7F show current paths for respective operational modes of the sustain discharge driving circuit according to some embodiments.

FIG. 8 shows a diagram of a sustain discharge driving circuit of a scan electrode driver according to some embodiments.

FIG. 9 shows a signal timing diagram of the sustain discharge driving circuit according to some embodiments.

FIG. 10A to FIG. 10H respectively show current paths for respective operation modes of the sustain discharge driving circuit according to some embodiments.

### DETAILED DESCRIPTION OF CERTAIN INVENTIVE EMBODIMENTS

In the following detailed description, only certain embodiments have been shown and described, simply by way of illustration. As those skilled in the art would realize, the described embodiments may be modified in various ways, without departing from the spirit or scope of the present invention. Accordingly, the drawings and description are to be regarded as illustrative in nature.

Throughout this specification and the claims which follow, when it is described that an element is “coupled” to another element, the element may be mechanically or electrically couple directly to the other element or indirectly through a third element. In addition, unless explicitly described to the contrary, the word “comprise” or variations such as “comprises” or “comprising” will be understood to imply the inclusion of stated elements but not the exclusion of other elements.

When it is described in the specification that a voltage is maintained, it should not be understood to strictly imply that the voltage is maintained exactly at a the voltage. To the contrary, even if a voltage difference between two points varies, the voltage difference is expressed to be maintained at a voltage in the case that the variance is within a range allowed within design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

A plasma display according to an embodiment and a driving device and method thereof will now be described with reference to figures.

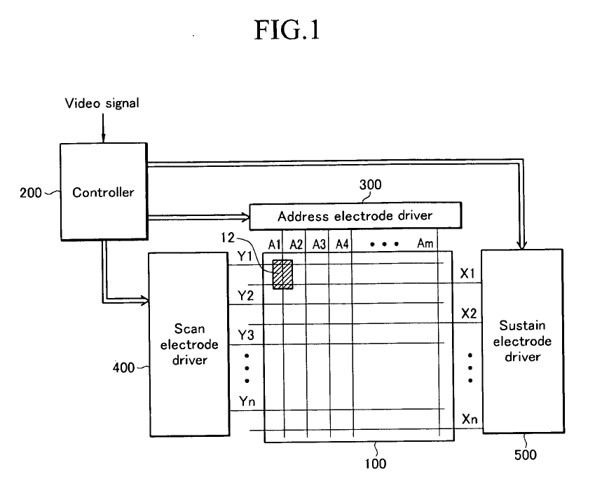

FIG. 1 shows a diagram representing the plasma display according to one embodiment. As shown in FIG. 1, the plasma display according to the embodiment includes a plasma display panel (PDP) 100, a controller 200, an address electrode driver 300, a scan electrode driver 400, and a sustain electrode driver 500.

The PDP 100 includes a plurality of address electrodes A1 to Am extending in a column direction, and a plurality of sustain and scan electrodes X1 to Xn and Y1 to Yn in pairs extending in a row direction. The X electrodes X1 to Xn are formed in correspondence to the Y electrodes Y1 to Yn, and a display operation is performed by the X and Y electrodes in the sustain period. The Y and X electrodes Y1 to Yn and X1 to Xn are arranged perpendicular to the A electrodes A1 to Am. Discharge cells 12 are formed near areas where the address electrodes A1 to Am cross the sustain and scan electrodes X1 to Xn and Y1 to Yn.

The configuration of the PDP 100 shown in FIG. 1 is an example, and other configurations may be used.

The controller 200 outputs X, Y, and A electrode driving control signals after receiving image signals. In addition, the controller 200 operates on each frame divided into a plurality of subfields having respective weight values, and each subfield includes a reset period, an address period, and a sustain period.

After receiving the A electrode driving control signal from the controller 200, the address electrode driver 300 applies display data signals for selecting discharge cells to be displayed to the respective address electrodes A1-Am.

The scan electrode driver 400 applies a driving voltage to the Y electrodes Y1 to Yn after receiving the Y electrode driving control signal from the controller 200, and the sustain electrode driver 500 applies a driving voltage to the X electrodes X1 to Xn after receiving the X electrode driving control signal from the controller 200.

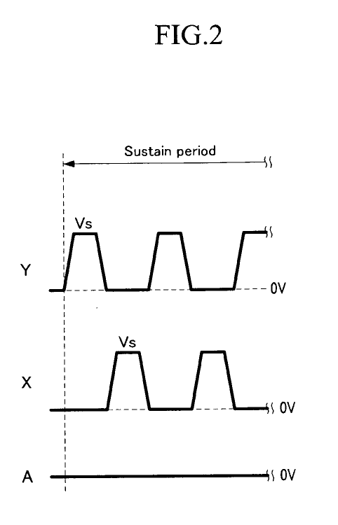

The plasma display according to some embodiments may have various driving waveform types. Driving waveforms of the plasma display device according to one embodiment will be described with reference to FIG. 2 to FIG. 4.

For convenience of description, a driving waveform applied to the Y, X, and A electrodes forming one cell will be described with reference to FIG. 2 to FIG. 4.

As shown in FIG. 2, in a driving waveform (hereinafter, referred to as a “first driving waveform”), a sustain pulse has a high level voltage (Vs voltage) and a low level voltage (0V voltage), and the sustain pulses of opposite phases are alternately applied to the Y and X electrodes during the sustain period. That is, during the sustain period, the 0V voltage is applied to the X electrode when the Vs voltage is applied to the Y electrode, and the 0V voltage is applied to the Y electrode when the Vs voltage is applied to the X electrode. Accordingly, during the sustain period, a voltage difference between the Y and X electrodes alternately becomes Vs and −Vs voltages, and therefore a sustain discharge is generated in a turn-on discharge cell a predetermined number of times that corresponds to a weight of the corresponding subfield.

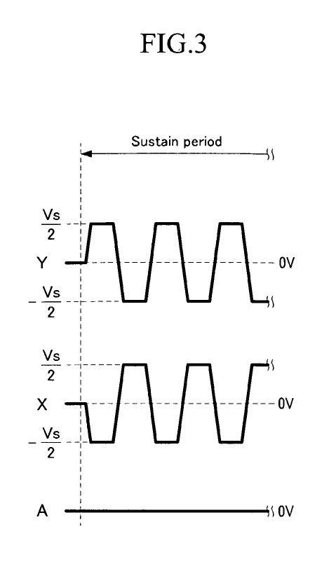

As shown in FIG. 3, in a driving waveform (hereinafter, referred to as a “second driving waveform”), a sustain pulse has a high level voltage (Vs/2 voltage) and a low level voltage (−Vs/2 voltage), and the sustain pulses of opposite phases are alternately applied to the Y and X electrodes during the sustain period. That is, during the sustain period, the −Vs/2 voltage is applied to the X electrode when the Vs/2 voltage is applied to the Y electrode, and the −Vs/2 voltage is applied to the Y electrode when the Vs/2 voltage is applied to the X electrode. In this case, the voltage difference between the Y and X electrodes alternately becomes Vs and −Vs voltages.

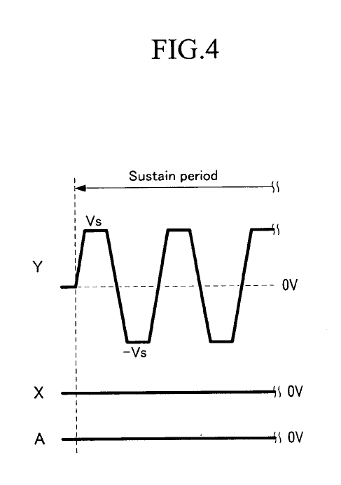

While it has been described that the scan electrode driver 400 and the sustain electrode driver 500 are used to apply the sustain pulse to the X and Y electrodes, one of the scan electrode driver 400 and the sustain electrode driver 500 may be used to apply the sustain pulse to one electrode between the X and Y electrodes, which will be described with reference to FIG. 4. FIG. 4 shows a diagram representing a driving waveform when the scan electrode driver 400 generates the sustain pulse.

As shown in FIG. 4, in a driving waveform (hereinafter, referred to as a “third driving waveform”), a sustain pulse alternately having a high level voltage (Vs voltage) and a low level voltage (−Vs voltage) is applied to the Y electrode while the 0V voltage is applied to the X electrode during the sustain period. Accordingly, the voltage difference between the Y and X electrodes alternately becomes the Vs and −Vs voltages during the sustain period.

Hereinafter, sustain discharge circuits of three types to generate the first to the third driving waveforms will now be described. The sustain discharge driving circuit generates the sustain pulse. In addition, the sustain discharge driving circuit or parts of the sustain discharge driving circuit may be formed in either the scan electrode driver or the sustain electrode driver, or in both.

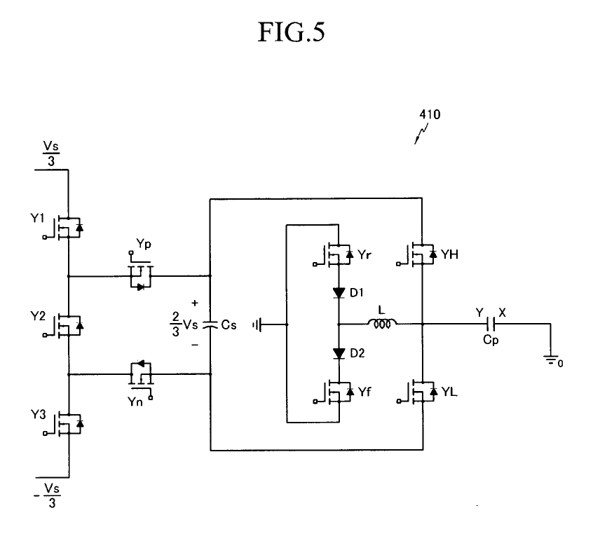

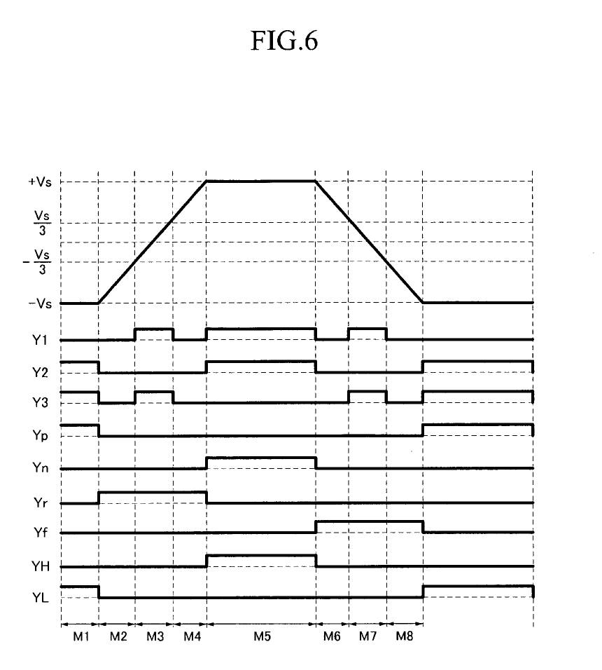

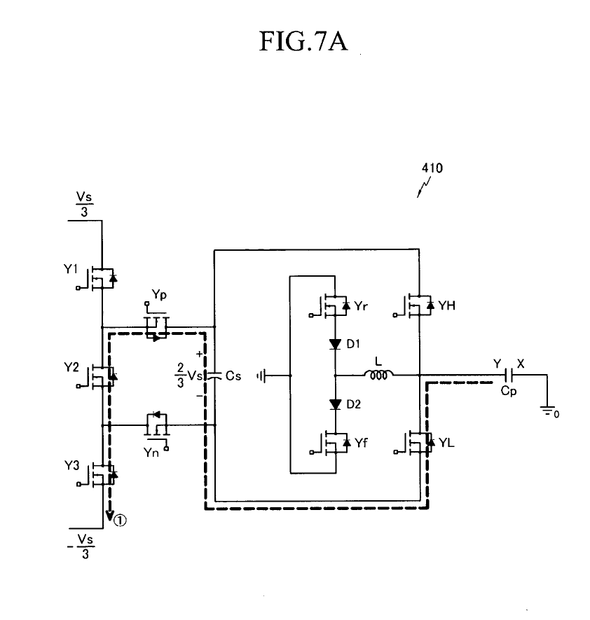

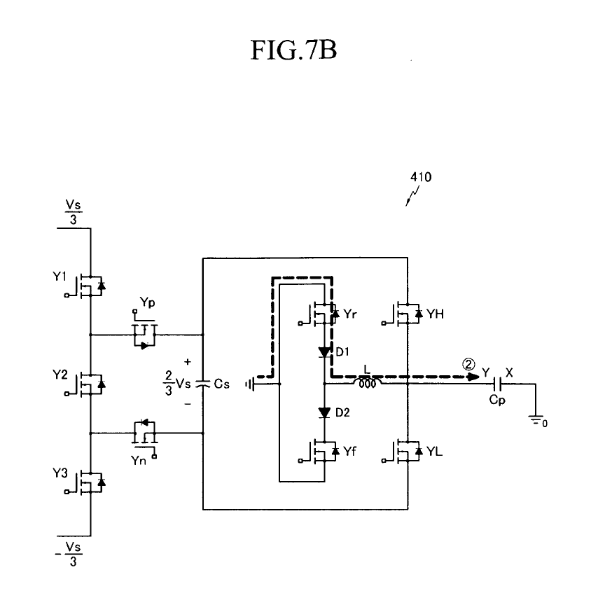

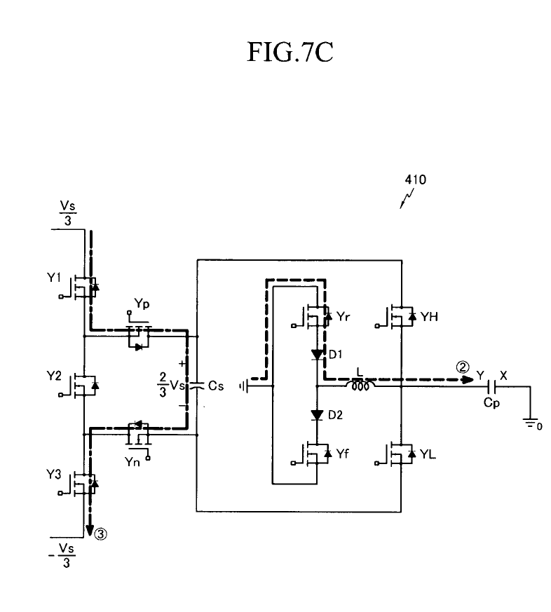

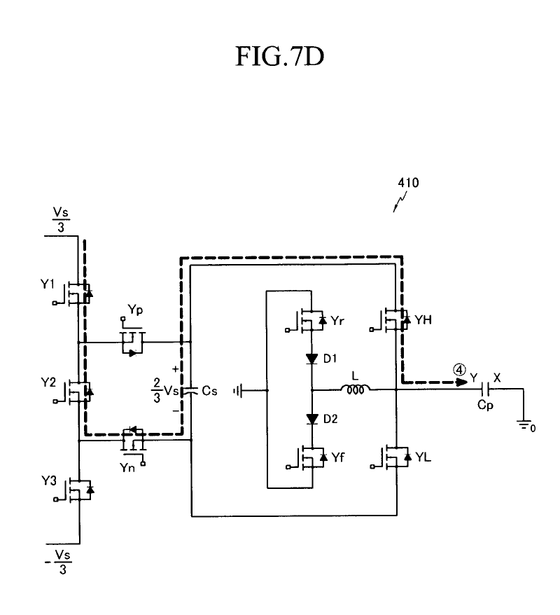

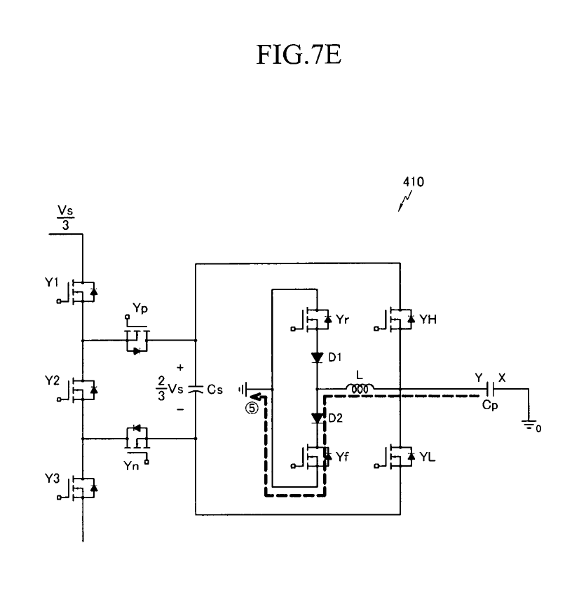

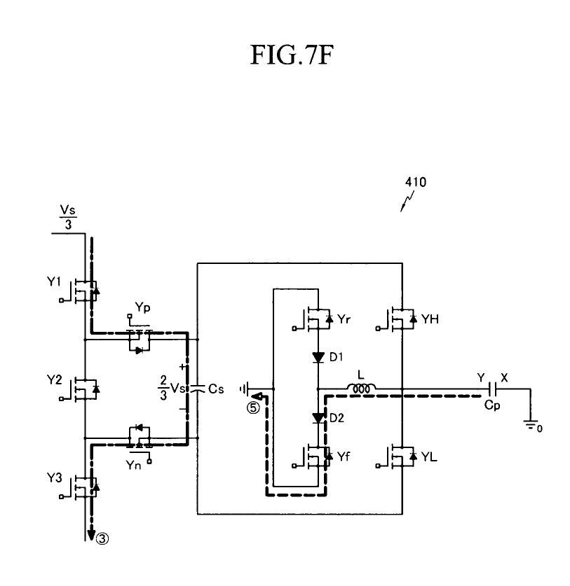

The sustain discharge driving circuit according to some embodiments, and operation thereof, will now be described with reference to FIG. 5, FIG. 6, and FIG. 7A to FIG. 7F.

In the sustain discharge driving circuit shown in FIG. 5, a power source voltage level is set to generate a sustain pulse for the third driving waveform.

As shown in FIG. 5, an output terminal of the sustain discharge driving circuit 410 formed in the scan electrode driver 400 is coupled to the plurality of Y electrodes Y1 to Yn. The plurality of X electrodes X1 to Xn are coupled to a ground terminal 0 to apply the 0V voltage to the X electrodes X1 to Xn during the sustain period.

For better understanding and ease of description, one X electrode and one Y electrode are illustrated, and a capacitance formed by the X and Y electrodes X and Y is illustrated as a panel capacitor Cp.

The sustain discharge driving circuit 410 includes transistors Y1, Y2, Y3, Yp, Yn, Yr, Yf, YH, and YL, a capacitor Cs, and a path separating unit comprising an inductor L, and diodes D1 and D2.

Here, the transistors Y1, Y2, Y3, Yp, Yn, Yr, Yf, YH, and YL are illustrated as n-channel field effect transistors, particularly n-channel metal oxide semiconductor (NMOS) transistors, and a body diode may be formed in a direction from a source to a drain in the respective transistors Y1, Y2, Y3, Yp, Yn, Yr, Yf, YH, and YL. Rather than using the NMOS transistor, other transistors having similar functions may be used as transistors Y1, Y2, Y3, Yp, Yn, Yr, Yf, YH, and YL.

While the transistors Y1, Y2, Y3, Yp, Yn, Yr, Yf, YH, and YL are respectively illustrated as a single transistor in FIG. 5, each of the transistors Y1, Y2, Y3, Yp, Yn, Yr, Yf, YH, and YL may be formed by a plurality of transistors coupled in parallel.

A drain of the transistor Y1 is coupled to a power source Vs/3 for supplying a Vs/3 voltage corresponding to one third of the high level voltage Vs of the sustain pulse, and a source of the transistor Y1 is coupled to a drain of the transistor Y2. In addition, a source of the transistor Y2 is coupled to a drain of the transistor Y3, and a source of the transistor Y3 is coupled to a power source −Vs/3 for supplying a −Vs/3 voltage corresponding to one third of the low level voltage −Vs of the sustain pulse.

A node of the source of transistor Y1 and the drain of the transistor Y2 is coupled to a source of the transistor Yp, and a node of the source of the transistor Y2 and the drain of the transistor Y3 is coupled to a drain of the transistor Yn.

A first terminal of the capacitor Cs is coupled to a drain of the transistor Yp, and a second terminal of the capacitor Cs is coupled to a source of the transistor Yn. In FIG. 5, the capacitor Cs is charged with a 2Vs/3 voltage through a path of the power source Vs/3, the transistor Y1, the transistor Yp, the capacitor Cs, the transistor Yn, the transistor Y3, and the power source −Vs/3.

A drain of the transistor YH is coupled to a node of the drain of the transistor Yp and the first terminal of the capacitor Cs, and a source of the transistor YH is coupled to the Y electrode. In addition, a source of the transistor YL is coupled to the source of the transistor Yn and the second terminal of the capacitor Cs, and a drain of the transistor YL is coupled to the Y electrode of the panel capacitor Cp.

A power source 0V is coupled to a node of a drain of the transistor Yr and a source of the transistor Yf, and a node of a source of the transistor Yr and a drain of the transistor Yf is coupled to a first terminal of the inductor L through diodes D1 and D2, respectively. A second terminal of the inductor L is coupled to the Y electrode of the panel capacitor Cp.

In this case, an anode of the diode D1 is coupled to the source of the transistor Yr, and a cathode thereof is coupled to the first terminal of the inductor L. A cathode of the diode D2 is coupled to the drain of the transistor Yf, and an anode thereof is coupled to the first terminal of the inductor L.

In this case, the diode D1 interrupts a current path formed by a body diode of the transistor Yr, and sets a voltage increasing path for increasing the voltage at the Y electrode. The diode D2 interrupts a current path formed by a body diode of the transistor Yf, and sets a voltage decreasing path for decreasing the voltage at the Y electrode.

While it is illustrated that one inductor L is coupled to a node of the diodes D1 and D2 in FIG. 5, the voltage increasing and decreasing paths respectively include inductors.

An operation of the sustain discharge driving circuit 410 for generating the sustain pulse for the third driving waveform will now be described with reference to FIG. 6 and FIG. 7A to FIG. 7F.

FIG. 6 shows a signal timing diagram of the sustain discharge driving circuit according to some embodiments, and FIG. 7A to FIG. 7F show current paths for respective operational modes of the sustain discharge driving circuit.

Firstly, it is assumed that the transistor Yf is turned on and the other transistors Y1, Y2, Y3, Yp, Yn, Yr, YH, and YL are turned off before a mode 1 M1 is started.

From the above state, when the transistor Yf is turned off and the transistors Y2, Y3, Yp, and YL are turned on at the mode 1 M1, a current path \textcircled{1} of the Y electrode of the panel capacitor Cp, the transistor YL, the capacitor Cs, the transistor Yp, the transistor Y2, the transistor Y3, and the power source −Vs/3 is formed, and the −Vs voltage is applied to the Y electrode through the current path \textcircled{1}, as shown in FIG. 7A. That is, the −Vs voltage, which is lower than the −Vs/3 power source voltage by the 2Vs/3 voltage charged at the capacitor Cs, is applied to the Y electrode.

In this case, since a drain voltage of the transistor YH is the −Vs/3 voltage by the path \textcircled{1} and the −Vs voltage is applied to the source of the transistor YH, the 2Vs/3 voltage is applied between the source and the drain of the transistor YH. Accordingly, the transistor YH may be used as a transistor having the 2Vs/3 voltage.

Since the drain voltage of the transistor Y1 is the Vs/3 voltage and a source voltage of the transistor Y1 is the −Vs/3 voltage at the mode 1 M1, the transistor Y1 may be used as the transistor having the 2Vs/3 voltage. In addition, since a drain voltage of the transistor Yn is the −Vs/3 voltage and a source voltage of the transistor Yn is the −Vs voltage, the transistor Yn may be used as the transistor having the 2Vs/3 voltage.

Subsequently, when the transistor Yr is turned on and the transistors Y2, Y3, Yp, and YL are turned off at a mode 2 M2, a current path \textcircled{2} of the ground terminal 0V, the transistor Yr, the diode D1, the inductor L, and the Y electrode of the panel capacitor Cp is formed, and an inductance-capacitance (LC) resonance is generated by the inductor L and the panel capacitor on the path \textcircled{2}. In this case, since a voltage at the ground terminal 0V is applied to the first terminal of the inductor L and the −Vs voltage is applied to the second terminal of the inductor L, a voltage at the Y electrode of the panel capacitor Cp is gradually increased from the −Vs voltage to the Vs voltage because of the LC resonance.

When the voltage at the Y electrode of the panel capacitor Cp is increased to the −Vs/3 voltage, a mode 3 M3 is started. When the transistors Y1 and Y3 are turned on at the mode 3 M3, a current path \textcircled{3} of the power source Vs/3, the transistors Y1 and Yp, the capacitor Cs, the transistors Yn and Y3, and the −power source Vs/3 is additionally formed as shown in FIG. 7C. The mode 3 M3 is maintained until the voltage at the Y electrode of the panel capacitor Cp is increased to Vs/3.

Accordingly, since voltages at the drain of the transistor YH and the source of the transistor YL are respectively the Vs/3 and −Vs/3 voltages when the capacitor Cs is charged with the 2Vs/3 voltage at the mode 3 M3, no current flows through the body diode of the transistor YH or the transistor YL by a voltage difference between the Vs/3 and −Vs/3 voltages. Accordingly, at the mode 3 M3, the current path \textcircled{2} is formed when the voltage at the Y electrode is between the −Vs/3 and Vs/3 voltages, and the capacitor Cs may be charged with the 2Vs/3 voltage, by turning on the transistors Y1 and Y3, through the current path \textcircled{3} of the power source Vs/3, the transistor Y1, the transistor Yp, the capacitor Cs, the transistor Yn, the transistor Y3, and the power source −Vs/3.

A mode 4 M4 is started when the voltage at the panel capacitor Cp is the Vs/3 voltage. At the mode 4 M4, the transistors Y1 and Y3 are turned off, the current path \textcircled{3} is eliminated, and the current path \textcircled{2} remains.

Subsequently, at a mode 5 M5, when the transistors Y1, Y2, Yn, and YH are turned on and the transistor Yr is turned off, a current path \textcircled{4} of the power source Vs/3, the transistor Y1, the transistor Y2, the transistor Yn, the capacitor Cs, the transistor YH, and the Y electrode of the panel capacitor Cp is formed, and the Vs voltage is applied to the Y electrode through the current path \textcircled{4}, as shown in FIG. 7D. That is, the Vs voltage, which is higher than the power source voltage Vs/3 by the 2Vs/3 of the voltage charged in the capacitor Cs, is applied to the Y electrode.

In this case, since a drain voltage of the transistor YL is the Vs voltage through the current path \textcircled{4} and the Vs/3 voltage is applied to the source of the transistor YL, the 2Vs/3 voltage is applied between the drain and the source of the transistor YL. Accordingly, the transistor YL may be used as the transistor having the 2Vs/3 voltage.

Since a drain voltage of the transistor Y3 is the Vs/3 voltage and the source voltage of the transistor Y3 is the −Vs/3 voltage, the transistor Y3 may be used as the transistor having the 2Vs/3 voltage. In addition, since a source voltage of the transistor Yp is the Vs/3 voltage and a drain voltage of the transistor Yp is the Vs voltage, the transistor Yp may be used as the transistor having the 2Vs/3 voltage.

Subsequently, when the transistor Yf is turned on and the transistors Y1, Y2, Yn, and YH are turned off at a mode 6 M6, a current path \textcircled{5} of the Y electrode of the panel capacitor Cp, the inductor L, the diode D2, the transistor Yf, and the power source 0V is formed, and the LC resonance is generated by the inductor L and the panel capacitor Cp on the current path \textcircled{5} as shown in FIG. 7E. Then, energy stored in the panel capacitor Cp is recovered to the power source 0V through the inductor L. In this case, the voltage at the Y electrode is decreased from the Vs voltage to the −Vs voltage.

When the voltage at the Y electrode of the panel capacitor Cp is decreased to the Vs/3 voltage, a mode 7 M7 is started. When the transistors Y1 and Y3 are turned on at the mode 7 M7, the current path \textcircled{3} of the power source Vs/3, the transistors Y1 and Yp, the capacitor Cs, the transistors Yn and Y3, and the power source −Vs/3 is additionally formed as shown in FIG. 7F. The mode 7 M7 is maintained until the voltage at the Y electrode of the panel capacitor Cp is the −Vs/3 voltage.

Accordingly, since the voltages at the drain of the transistor YH and the source of the transistor YL are respectively the Vs/3 and −Vs/3 voltages when the capacitor Cs is charged with the 2Vs/3 voltage at the mode 7 M7, no current flows from the Y electrode through the body diode of the transistor YH or the transistor YL by the voltage difference between the Vs/3 and −Vs/3 voltages. Therefore, at the mode 7 M7, the current path \textcircled{5} is formed when the voltage at the Y electrode is between the −Vs/3 and Vs/3 voltages, and the capacitor Cs is charged with the 2Vs/3 voltage through the current path \textcircled{3} by turning on the transistors Y1 and Y3 as shown in FIG. 7F.

A mode 8 M8 is started when the voltage at the panel capacitor Cp is the −Vs/3 voltage. At the mode 8 M8, the transistors Y1 and Y3 are turned off, the current path \textcircled{3} is eliminated, and the current path \textcircled{5} remains.

Since the modes 1 to 8 M1 to M8 are repeatedly performed a number of times that corresponds to a weight of the corresponding subfield, the Vs voltage and the −Vs voltage are alternately applied to the Y electrode. In addition, the transistors YH and YL may be used while having only the voltage corresponding to one third of the voltage applied to the Y electrode (i.e., the 2Vs/3 voltage), and the transistors Y1, Y2, Y3, Yp, and Yn may be used while having only the 2Vs/3 voltage.

The sustain discharge driving circuit for generating the sustain pulse for the first driving waveform will now be described with reference to FIG. 5.

The sustain discharge driving circuit for generating the sustain pulse for the first driving waveform is formed by adjusting the power source voltage level of the sustain discharge driving circuit 410 shown in FIG. 5. The sustain discharge driving circuit having the adjusted power source voltage level may be formed in the scan electrode driver 400 and/or in the sustain electrode driver 500.

In further detail, in the sustain discharge driving circuit for generating the sustain pulse for the first driving waveform, the voltage of the power source coupled to the drain of the transistor Y1 of the circuit shown in FIG. 5 is set to be the 2Vs/3 voltage, the voltage of the power source coupled to the source of the transistor Y3 is set to be the Vs/3 voltage, and the voltage of the power source coupled to the node of the drain of the transistor Yr and the source of the transistor Yf is set to be the Vs/2 voltage.

Accordingly, when the transistors Y2, Yp, and Yn are turned off and the transistors Y1 and Y3 are turned on, the capacitor Cs is charged with the Vs/3 voltage, and the sustain pulse alternately having the 0V voltage and the Vs voltage may be applied to the Y electrode through the paths shown in FIG. 7A to FIG. 7F.

The sustain discharge driving circuit for generating the sustain pulse for the second driving waveform will now be described with reference to FIG. 5.

The sustain discharge driving circuit for generating the sustain pulse for the second driving waveform is formed by adjusting the power source voltage of the sustain discharge driving circuit 410 shown in FIG. 5. The sustain discharge driving circuit having the adjusted power source voltage level may be formed in the scan electrode driver 400 and/or the sustain electrode driver 500.

In further detail, in the sustain discharge driving circuit for generating the sustain pulse for the second driving waveform, the voltage of the power source coupled to the drain of the transistor Y1 in the circuit shown in FIG. 5 is set to be a Vs/6 voltage, and the voltage of the power source coupled to the source of the transistor Y3 is set to be a −Vs/6 voltage. Accordingly, when the transistors Y2, Yp, and Yn are turned off and the transistors Y1 and Y3 are turned on, the capacitor Cs is charged with the Vs/3 voltage, and the sustain pulse alternately having the Vs/2 voltage and the −Vs/2 voltage may be applied to the Y electrode through the paths shown in FIG. 7A to FIG. 7F.

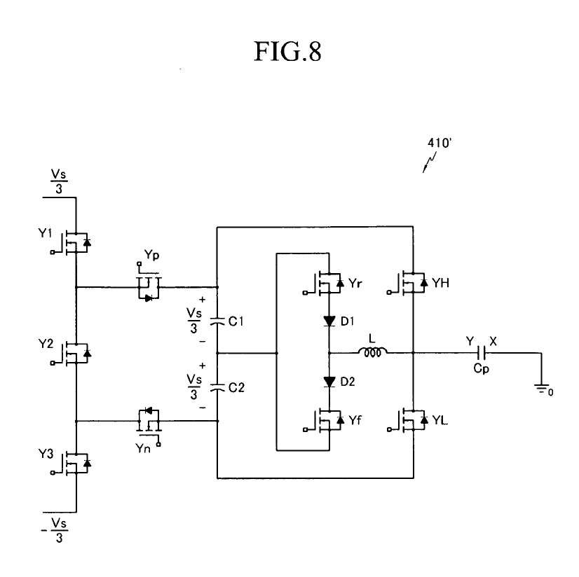

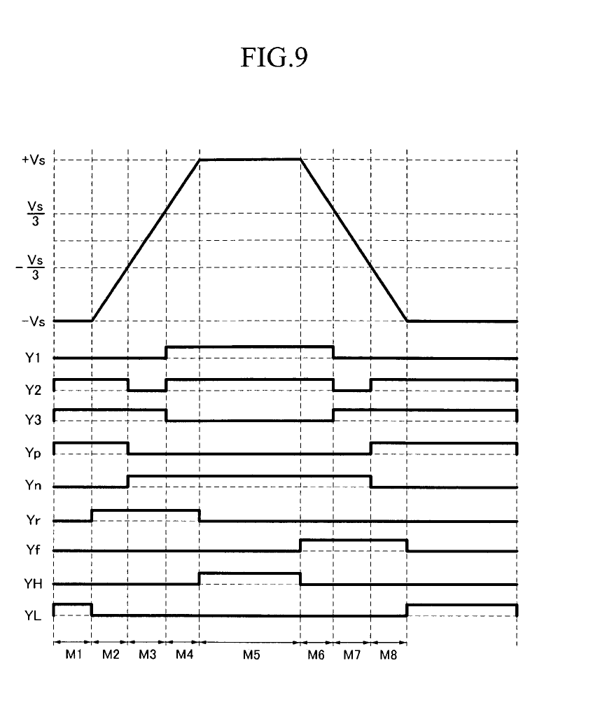

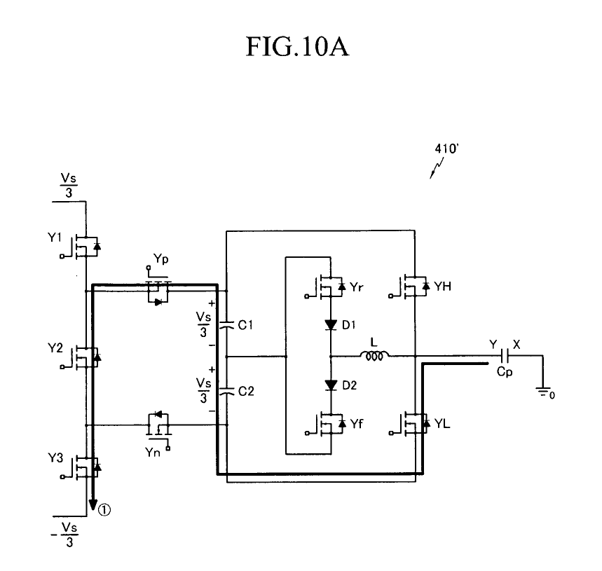

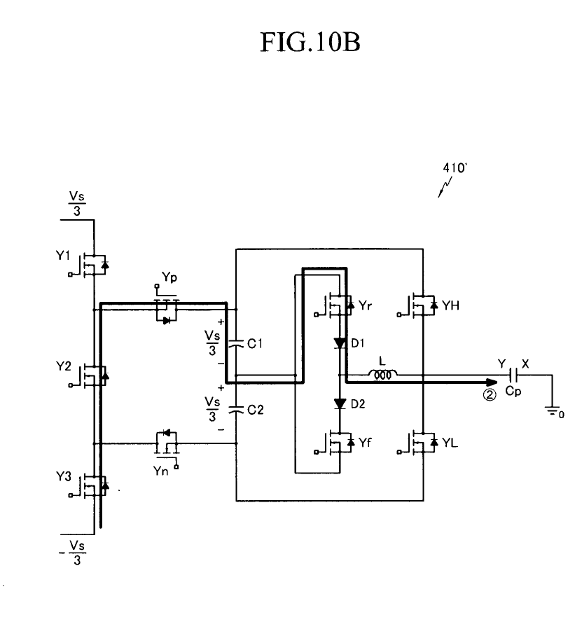

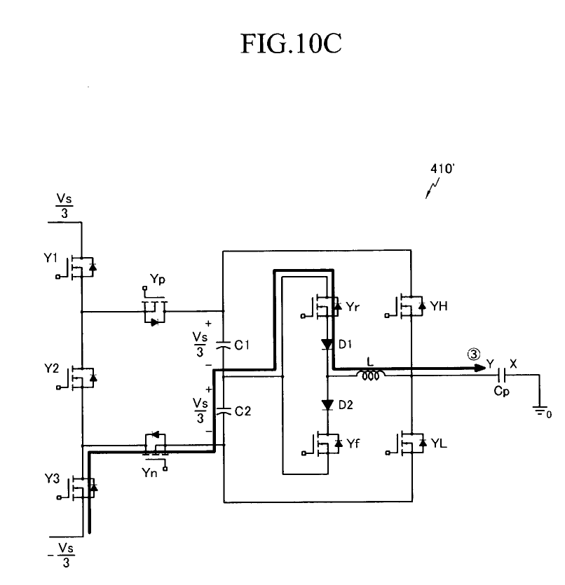

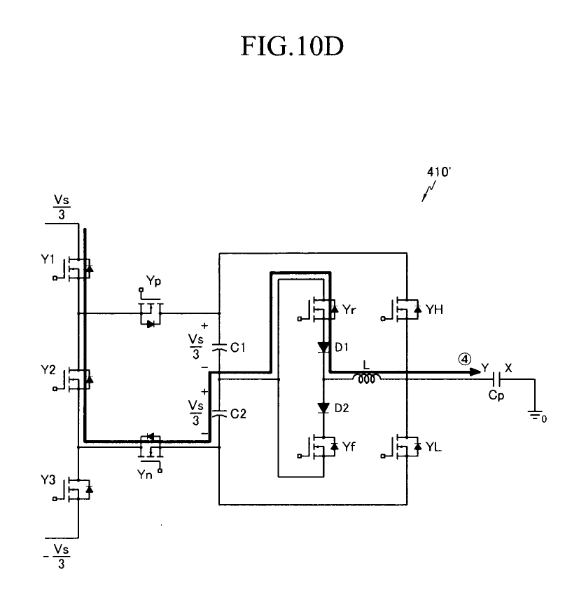

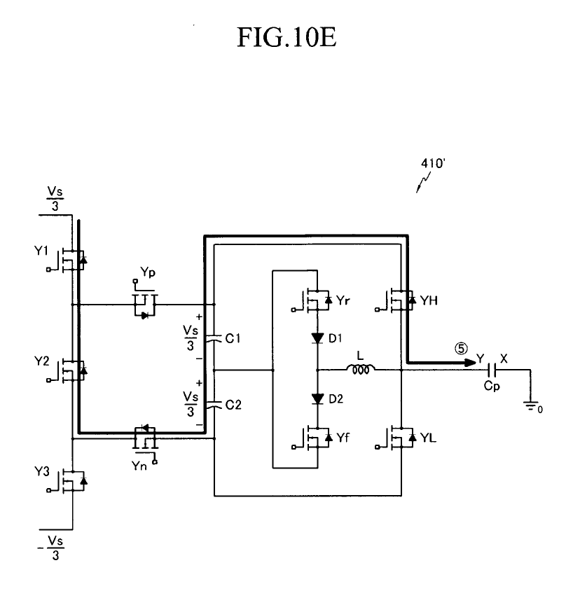

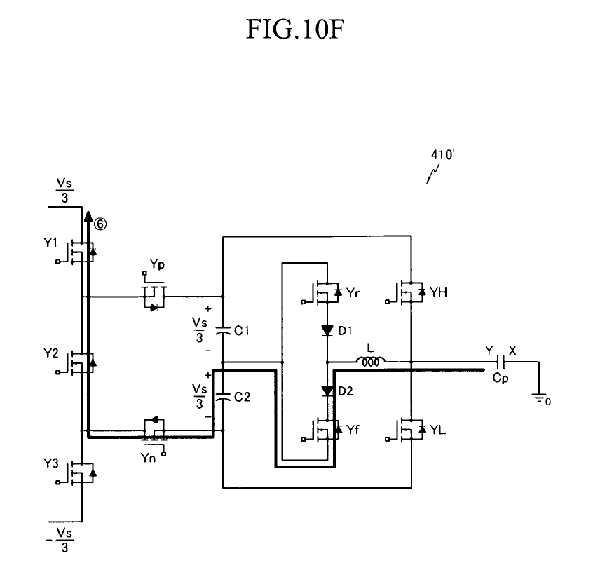

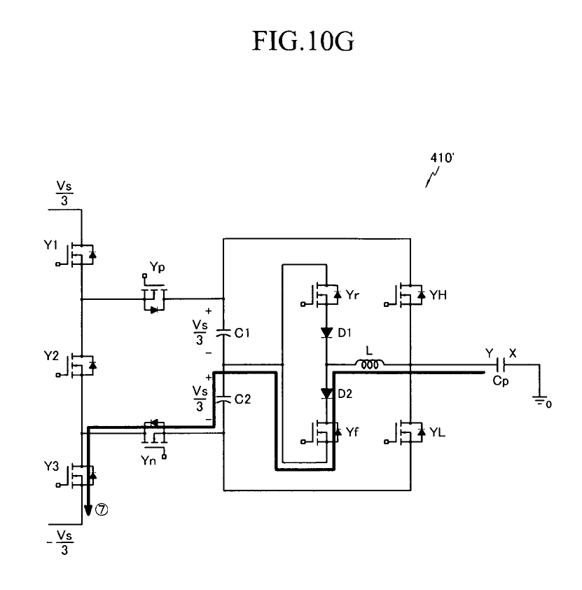

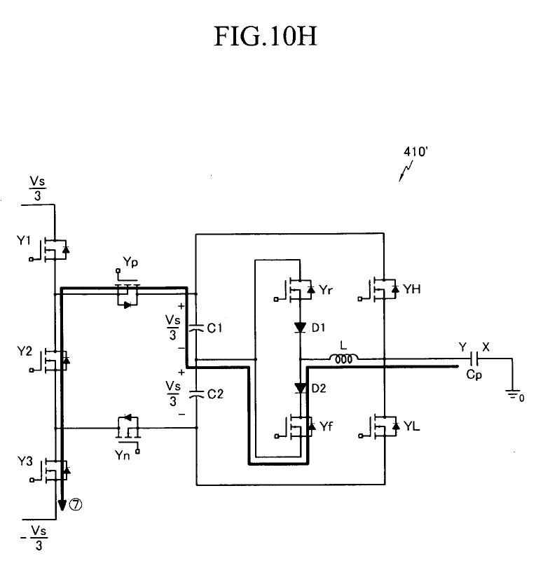

A sustain discharge driving circuit according to another embodiment and an operation thereof will now be described with reference to FIG. 8, FIG. 9, and FIG. 10A to FIG. 10F.

The sustain discharge driving circuit according to some embodiments shown in FIG. 8 has the power source voltage level to generate the sustain pulse for the third driving waveform.

As shown in FIG. 8, the sustain discharge driving circuit 410′ includes the transistors Y1, Y2, Y3, Yp, Yn, Yr, Yf, YH, and YL, capacitors C1 and C2, and a path separating unit comprising the inductor L, and the diodes D1 and D2.

In FIG. 8, the transistors Y1, Y2, Y3, Yp, Yn, Yr, Yf, YH, and YL are illustrated as n-channel field effect transistors, particularly n-channel metal oxide semiconductor (NMOS) transistors, and a body diode may be formed in a direction from a source to a drain in the respective transistors Y1, Y2, Y3, Yp, Yn, Yr, Yf, YH, and YL. Rather than using the NMOS transistor, other transistors having similar functions may be used as transistors Y1, Y2, Y3, Yp, Yn, Yr, Yf, YH, and YL.

While the transistors Y1, Y2, Y3, Yp, Yn, Yr, Yf, YH, and YL are respectively illustrated as a single transistor in FIG. 8, each of the transistors Y1, Y2, Y3, Yp, Yn, Yr, Yf, YH, and YL may be formed by a plurality of transistors coupled in parallel.

The drain of the transistor Y1 is coupled to the power source Vs/3 for supplying the Vs/3 voltage corresponding to one third of the high level voltage Vs of the sustain pulse, and the source of the transistor Y1 is coupled to the drain of the transistor Y2. In addition, the source of the transistor Y2 is coupled to the drain of the transistor Y3, and the source of the transistor Y3 is coupled to the power source −Vs/3 for supplying the −Vs/3 voltage corresponding to one third of the low level voltage −Vs of the sustain pulse.

The node of the source of transistor Y1 and the drain of the transistor Y2 is coupled to the source of the transistor Yp, and the node of the source of the transistor Y2 and the drain of the transistor Y3 is coupled to the drain of the transistor Yn.

A first terminal of the capacitor C1 is coupled to the drain of the transistor Yp, and a second terminal thereof is coupled to a first terminal of the capacitor C2. A second terminal of the capacitor C2 is coupled to the source of the transistor Yn. In the circuit of FIG. 8, when the transistors Y1, Yp, Yn, and Y3 are turned on the respective capacitors C1 and C2 are charged with the Vs/3 voltage through a path of the power source Vs/3, the transistor Y1, the transistor Yp, the capacitor C1, the capacitor C2, the transistor Yn, the transistor Y3, and the power source −Vs/3.

The drain of the transistor YH is coupled to a node of the drain of the transistor Yp and the first terminal of the capacitor C1, and the source of the transistor YH is coupled to the Y electrode of the panel capacitor Cp. The source of the transistor YL is coupled to a node of the source of the transistor Yn and the second terminal of the capacitor C2, and the drain of the YL is coupled to the Y electrode of the panel capacitor Cp.

A node of the second terminal of the capacitor C1 and the first terminal of the capacitor C2 is respectively coupled to the drain of the transistor Yr and the source of the transistor Yf, and the node of the source of the transistor Yr and the drain of the transistor Yf is coupled to the first terminal of the inductor L through diodes D1 and D2, respectively. The second terminal of the inductor L is coupled to the Y electrode of the panel capacitor Cp.

The anode of the diode D1 is coupled to the source of the transistor Yr, and the cathode thereof is coupled to the first terminal of the inductor L. The cathode of the diode D2 is coupled to the drain of the transistor Yf, and the anode thereof is coupled to the first terminal of the inductor L.

The diode D1 interrupts a current path formed by a body diode of the transistor Yr, and sets a voltage increasing path for increasing the voltage at the Y electrode. The diode D2 interrupts a current path formed by a body diode of the transistor Yf, and sets a voltage decreasing path for decreasing the voltage at the Y electrode.

While it is illustrated that one inductor L is coupled to the node of the diodes D1 and D2 in FIG. 8, the voltage increasing and decreasing paths respectively can each include inductors.

An operation of the sustain discharge driving circuit 410′ will now be described with reference to FIG. 9 and FIG. 10A to FIG. 10H.

FIG. 9 shows a signal timing diagram of the sustain discharge driving circuit according to some embodiments, and FIG. 10A to FIG. 10H respectively show current paths for respective operation modes of the sustain discharge driving circuit.

Firstly, it is assumed that the transistors Y2, Y3, Yp, and Yf are turned on and the other transistors Y1, Yn, Yr, YH, and YL are turned off before a mode 1 M1 is started.

Referring to FIG. 9 and FIG. 10A, at the mode 1 M1, the transistor Yf is turned off and the transistor YL is turned on. Accordingly, a current path \textcircled{1} of the Y electrode of the panel capacitor Cp, the transistor YL, the capacitor C2, the capacitor C1, the transistor Yp, the transistor Y2, the transistor Y3, and the power source −Vs/3 is formed, and the −Vs voltage is applied to the Y electrode through the path \textcircled{1}. That is, the −Vs voltage which is lower than the −Vs/3 source voltage by a sum 2Vs/3 of the voltages charged in the capacitors C1 and C2, is applied to the Y electrode.

In this case, since the −Vs/3 voltage is applied to the drain of the transistor Y and the −Vs voltage is applied to the source of the transistor YH, the 2Vs/3 voltage is applied between the source and drain of the transistor YH. Accordingly, the transistor YH has only 2Vs/3 voltage across it.

Since the voltage at the drain of the transistor Y1 is the Vs/3 voltage and the voltage at the source of the transistor Y1 is the −Vs/3 voltage, the transistor Y1 has only 2Vs/3 voltage across it. In addition, since the voltage at the drain of the transistor Yn and the voltage at the source of the transistor Yn is the −Vs voltage, the transistor Yn has only 2Vs/3 voltage across it.

Subsequently, at the mode 2 M2, the transistor Yr is turned on and the transistor YL is turned off. Accordingly, as shown in FIG. 10B, a current path \textcircled{2} of the power source −Vs/3, the transistor Y3, the transistor Y2, the transistor Yp, the capacitor C1, the transistor Yr, the diode D1, the inductor L, and the Y electrode of the panel capacitor Cp is formed, and the LC resonance is generated by the inductor L and the panel capacitor Cp on the path \textcircled{2}. In this case, the voltage at the Y electrode of the panel capacitor Cp is increased from the −Vs voltage to the Vs/3 voltage by the LC resonance.

Subsequently, at the mode 3 M3, the transistors Y2 and Yp are turned off, and the transistor Yn is turned on. Accordingly, as shown in FIG. 10C, a current path Q of the power source −Vs/3, the transistor Y3, the transistor Yn, the capacitor C2, the transistor Yr, the diode D1, the inductor L, and the Y electrode of the panel capacitor Cp is formed, and the LC resonance is generated by the inductor L and the panel capacitor Cp on the current path \textcircled{3}. In this case, the voltage at the Y electrode of the panel capacitor Cp is increased from the −Vs/3 voltage and the Vs/3 voltage by the LC resonance.

At the mode 4 M4, the transistor Y3 is turned off, and the transistors Y1 and Y2 are turned on. Accordingly, as shown in FIG. 10D, a current path \textcircled{4} of the power source Vs/3, the transistor Y1, the transistor Y2, the transistor Yn, the capacitor C2, the transistor Yr, the diode D1, the inductor L, and the Y electrode of the panel capacitor Cp is formed, and the LC resonance is generated by the inductor L and the panel capacitor Cp on the current path \textcircled{4}. In this case, the voltage at the Y electrode of the panel capacitor Cp is increased from the Vs/3 voltage to the Vs voltage.

At the mode 5 M5, the transistor Yr is turned off, and the transistor YH is turned on. Accordingly, as shown in FIG. 10E, a current path \textcircled{5} of the power source Vs/3, the transistor Y1, the transistor Y2, the transistor Yn, the capacitor C2, the capacitor C1, the transistor YH, and the Y electrode of the panel capacitor Cp is formed, and the Vs voltage is applied to the Y electrode through the current path \textcircled{5}. That is, the Vs voltage which is higher than the Vs/3 power source voltage by a sum 2Vs/3 of the voltages charged in the capacitors C1 and C2 is applied to the Y electrode.

In this case, since the Vs voltage is applied to the drain of the transistor YL and the Vs/3 voltage is applied to the source of the transistor YL through the current path \textcircled{5}, the 2Vs/3 voltage is applied between the drain and source of the transistor YL. Accordingly, the transistor YL may be used as a transistor having the 2Vs/3 voltage.

In addition, since the voltage at the drain of the transistor Y3 is the Vs/3 voltage and the voltage at the source of the transistor Y1 is the −Vs/3 voltage, the transistor Y3 has only 2Vs/3 voltage across it. In addition, since the voltage at the source of the transistor Yp is the Vs/3 voltage and the voltage at the drain of the transistor Yp is the Vs voltage, the transistor Yp has only 2Vs/3 voltage across it.

Subsequently, at the mode 6 M6, the transistor YH is turned off, and the transistor Yf is turned on. Accordingly, as shown in FIG. 10F, a current path \textcircled{6} of the Y electrode of the panel capacitor Cp, the inductor L, the diode D2, the transistor Yf, the capacitor C2, the transistor Yn, the transistor Y2, the transistor Y1, and the power source Vs/3 is formed, and the LC resonance is generated by the inductor L and the panel capacitor Cp on the current path \textcircled{6}. Then, energy stored in the panel capacitor Cp is recovered to the power source Vs/3 through the inductor L, and the voltage at the Y electrode is decreased from the Vs voltage to the Vs/3 voltage.

At the mode 7 M7, the transistors Y1 and Y2 are turned off, and the transistor Y3 is turned on. Accordingly, as shown in FIG. 10G, a current path \textcircled{7} of the Y electrode of the panel capacitor Cp, the inductor L, the diode D2, the transistor Yf, the capacitor C2, the transistor Yn, the transistor Y3, and the power source −Vs/3 is formed, and the LC resonance is generated by the inductor L and the panel capacitor Cp on the current path \textcircled{7}. The energy stored in the panel capacitor Cp is recovered to the power source −Vs/3 through the inductor L, and the voltage at the Y electrode is decreased from the Vs/3 voltage to the −Vs/3 voltage.

At the mode 8 M8, the transistor Yn is turned off, and the transistors Y2 and Yp are turned on. Accordingly, as shown in FIG. 10H, a current path \textcircled{8} of the Y electrode of the panel capacitor Cp, the inductor L, the diode D2, the transistor Yf, capacitor C1, the transistor Yp, the transistor Y2, the transistor Y3, and the power source −Vs/3 is formed, and the LC resonance is generated by the inductor L and the panel capacitor Cp on the current path \textcircled{8}. Then, the energy stored in the panel capacitor Cp is recovered to the power source −Vs/3 through the inductor L, and the voltage at the Y electrode is decreased from the −Vs/3 voltage to the −Vs voltage.

As described, since the modes 1 to 8 M1 to M8 are repeatedly performed a number of times that corresponds to a weight of the corresponding subfield, the Vs voltage and the −Vs voltage are alternately applied to the Y electrode. In addition, the transistors YH and YL may have one third of the voltage applied to the Y electrode (i.e., the 2Vs/3 voltage) across it, and the transistors Y1, Y2, Y3, Yn, and Yp may have the 2Vs/3 voltage across them.

The sustain discharge driving circuit for generating the sustain pulse for the first driving waveform will now be described with reference to FIG. 8.

The sustain discharge driving circuit for generating the sustain pulse for the first driving waveform is formed by adjusting the power source voltage level of the sustain discharge driving circuit 410′ shown in FIG. 8. The sustain discharge driving circuit having the adjusted power source voltage level may be formed in the scan electrode driver 400 and/or the sustain electrode driver 500.

In further detail, in the sustain discharge driving circuit for generating the sustain pulse for the first driving waveform, the voltage of the power source coupled to the drain of the transistor Y1 of the circuit 401′ shown in FIG. 8 is set to be the 2Vs/3 voltage, and the voltage of the power source coupled to the source of the transistor Y3 is set to be the Vs/3 voltage. Accordingly, when the transistors Y1, Yp, Yn, and Y3 are turned on, the Vs/6 voltage is respectively charged in the capacitors C1 and C2, and the sustain pulse alternately having the 0V voltage and the Vs voltage may be applied to the Y electrode through the paths shown in FIG. 10A to FIG. 10H.

The sustain discharge driving circuit for generating the sustain pulse for the second driving waveform will now be described with reference to FIG. 8.

The sustain discharge driving circuit for generating the sustain pulse for the second driving waveform is formed by adjusting the power source voltage level of the sustain discharge driving circuit 410′ shown in FIG. 8. The sustain discharge driving circuit having the adjusted power source voltage level may be formed in the scan electrode driver 400 and/or the sustain electrode driver 500.

In further detail, in the sustain discharge driving circuit for generating the sustain pulse for the second driving waveform, the voltage of the power source coupled to the drain of the transistor Y1 in the circuit 410′ shown in FIG. 8 is set to be a Vs/6 voltage, and the voltage of the power source coupled to the source of the transistor Y3 is set to be a −Vs/6 voltage. Accordingly, when the transistors Y1, Yp, Yn, and Y3 are turned on, the Vs/6 voltage is respectively charged in the capacitors C1 and C2, and the sustain pulse alternately having the Vs/2 voltage and the −Vs/2 voltage may be applied to the Y electrode through the paths shown in FIG. 10A to FIG. 10H.

While this invention has been described in connection with what is presently considered to be practical embodiments, it is to be understood that the invention is not limited to the disclosed embodiments, but, on the contrary, is intended to cover various modifications.

According to the exemplary embodiments of the present invention, a transistor having a low voltage may be used in a sustain discharge driving circuit.

What is claimed is:

1. A plasma display comprising:
a plurality of first electrodes;
a first transistor having a first terminal coupled to a first power source, the first power source configured to supply a first voltage;
a second transistor having a first terminal coupled to a second terminal of the first transistor;
a third transistor having a first terminal coupled to a second terminal of the second transistor and a second terminal coupled to a second power source, the second power source configured to supply a second voltage, the second voltage being lower than the first voltage;
a fourth transistor having a first terminal coupled to the second terminal of the first transistor;
a fifth transistor having a first terminal coupled to the second terminal of the second transistor;
a charging power source coupled to a second terminal of the fourth transistor and a second terminal of the fifth transistor;
a sixth transistor coupled to the second terminal of the fourth transistor, and coupled to one or more of the plurality of first electrodes;
a seventh transistor coupled to the second terminal of the fifth transistor, and coupled to one or more of the plurality of first electrodes;
an inductor having a first terminal coupled to the sixth transistor and to the seventh transistor; and
a path separating unit comprising:
a first node selectively coupled to one of the charging power source and a third power source configured to supply a third voltage;
a second node coupled to a second terminal of the inductor;
first and second current paths, wherein the first current path conducts current from the first node to the second node, and the second current path conducts current from the second node to the first node,
wherein the first node is coupled to the charging power source when a voltage at the one or more of the plurality of first electrodes is substantially stable, and the first node is coupled to the third power source when the voltage at the one or more of the plurality of first electrodes is changing.

2. The plasma display of claim 1, wherein the first current path comprises an eighth transistor having a first terminal coupled to the first node through a first diode having an anode coupled to a second terminal of the seventh transistor and a cathode coupled to the second terminal of the inductor, and the second current path comprises a ninth transistor having a second terminal coupled to the first node through a second diode having an anode coupled to the second terminal of the inductor and a cathode coupled to the first terminal of the eighth transistor.

3. The plasma display of claim 2, wherein the charging power source comprises first and second capacitors charged with voltages having substantially the same level, and the first node is selectively coupled to a node to which the first and second capacitors are connected.

4. The plasma display of claim 2, wherein the charging power source comprises one capacitor, and the first node is selectively coupled to a ground power source.

5. The plasma display of claim 3, wherein the first voltage is a positive voltage, the second voltage is a negative voltage, and the third voltage is a ground voltage.

6. The plasma display of claim 3, wherein the first, second, and third voltages respectively have positive voltage levels.

7. The plasma display of claim 4, wherein the first voltage is a positive voltage, the second voltage is a negative voltage, and the third voltage is a ground voltage.

8. The plasma display of claim 4, wherein the first, second, and third voltages respectively have positive or ground voltage levels.

9. The plasma display of claim 4, wherein the display is configured such that:
while the second, third, fourth, and seventh transistors are on and a voltage corresponding to a difference between the second voltage and a voltage charged in the capacitor is applied to the plurality of first electrodes,
the second, third, fourth, and seventh transistors are turned off, and the eighth transistor is turned on and the voltage at the plurality of first electrodes is increased, and
when the eighth transistor is turned off, and the first, second, fifth, and sixth transistors are turned on, a voltage corresponding to a sum of the first voltage and the voltage charged in the capacitor is applied to the plurality of first electrodes.

10. The plasma display of claim 9, wherein, the display is further configured such that while the first, second, fifth, and sixth transistors are on, and the voltage corresponding to the sum of the first voltage and the voltage charged in the capacitor is applied to the plurality of first electrodes,
the first, second, fifth, and sixth transistors are turned off, the ninth transistor is turned on, and the voltage at the plurality of first electrodes is decreased, and
when the ninth transistor is turned off, the second, third, fourth, and seventh transistors are turned on, and the voltage corresponding to the difference between the second voltage and the voltage charged in the capacitor is applied to the plurality of first electrodes.

11. The plasma display of claim 3, wherein, the display is further configured such that while the second, third, fourth, and seventh transistors are turned on, and a voltage corresponding to a difference between the second voltage and a voltage charged in the first and second capacitors is applied to the plurality of first electrodes,
the seventh transistor is turned off, the eighth transistor is turned on, and the voltage at the plurality of first electrodes is increased,
when the second transistor is turned off, the fifth transistor is turned on, and the voltage at the plurality of first electrodes is increased,
when the third transistor is turned off, the first, second transistors are turned on, the voltage at the plurality of first electrodes is increased, and
when the eighth transistor is turned off, the sixth transistor is turned on, and a voltage corresponding to a sum of the first voltage and the voltage charged in the first and second capacitors is applied to the plurality of first electrodes.

12. The plasma display of claim 11, wherein, the display is further configured such that while the first, second, fifth, and sixth transistors are on, and the voltage corresponding to the sum of the first voltage and the voltage charged in the first and second capacitors is applied to the plurality of first electrodes:
when the sixth transistor is turned off, the ninth transistor is turned on, and the voltage at the plurality of first electrodes is decreased;
when the first and second transistors are turned off, the third transistor is turned on, and the voltage at the plurality of first electrodes is decreased;
when the fifth transistor is turned off, the second and fourth transistors are turned on, and the voltage at the plurality of first electrodes is decreased, and
when the ninth transistor is turned off, the seventh transistor is turned on, and the voltage corresponding to the difference between the second voltage and the voltage charged in the first and second capacitors is applied to the plurality of first electrodes.

13. A method of driving a plasma display comprising a plurality of first electrodes, the driving method comprising:
applying a third voltage to the plurality of first electrodes with a first power source configured to supply a first voltage and a capacitor charged with a second voltage;
increasing a voltage at the plurality of first electrodes through a first resonance path, the path comprising a first inductor and a second power source configured to supply a fourth voltage, the fourth voltage being higher than the first voltage;
applying a sixth voltage to the plurality of first electrodes with the capacitor and a third power source configured to supply a fifth voltage, the fifth voltage being higher than the fourth voltage; and
decreasing the voltage at the plurality of first electrodes with a second resonance path comprising the second power source and a second inductor.

14. The driving method of claim 13, wherein the first resonance path further comprises a first transistor coupled between the second power source and the first inductor, and
the second resonance path further comprises a second transistor coupled between the second power source and the second inductor.

15. The driving method of claim 14, wherein the increasing or decreasing of the voltage at the plurality of first electrodes further comprises
charging the capacitor with the second voltage through a charging path comprising the third power source, the capacitor, and the first power source.

16. The driving method of claim 14, wherein the first inductor and the second inductor are the same inductor.

17. A driving method for driving a plasma display comprising a plurality of first electrodes, the driving method comprising:
applying a third voltage to the plurality of first electrodes with a first power source configured to supply a first voltage, and first and second capacitors each charged with a second voltage;
increasing a voltage at the plurality of first electrodes through a first resonance path, the path comprising the first power source, the first capacitor, and a first inductor;
further increasing the voltage at the plurality of first electrodes through a second resonance path comprising the first power source, the second capacitor, and the first inductor;
further increasing the voltage at the plurality of first electrodes through a third resonance path comprising a second power source, the second capacitor, and the first inductor;
applying a fourth voltage to the plurality of first electrodes with the second power source, the first capacitor, and the second capacitor;
decreasing the voltage at the plurality of first electrodes through a fourth resonance path comprising the second inductor, the second capacitor, and the second power source;
further decreasing the voltage at the plurality of first electrodes through a fifth resonance path comprising the second inductor, the second capacitor, and the first power source; and
further decreasing the voltage at the plurality of first electrodes through a sixth resonance path comprising the second inductor, the first capacitor, and the first power source.

18. The driving method of claim 17, wherein the first, second and third resonance paths each further comprise a first transistor coupled between the first power source and the first inductor, and
the fourth, fifth, and sixth resonance paths each further comprise a second transistor coupled between the second power source and the second inductor.

19. The driving method of claim 18, wherein the first and second inductors are the same inductor.

20. A driving device configured to drive a plasma display comprising a plurality of first electrodes, the driving device comprising:
a first transistor having a first terminal coupled to a first power source, the first power source configured to supply a first voltage;
a second transistor having a first terminal coupled to a second terminal of the first transistor;
a third transistor having a first terminal coupled to a second terminal of the second transistor and a second terminal coupled to a second power source, the second power source configured to supply a second voltage, the second voltage being lower than the first voltage;
a fourth transistor having a first terminal coupled to the second terminal of the first transistor;
a fifth transistor having a first terminal coupled to the second terminal of the second transistor;
a charging power source coupled to a second terminal of the fourth transistor and a second terminal of the fifth transistor;
a sixth transistor coupled to one or more of the plurality of first electrodes and the second terminal of the fourth transistor;
a seventh transistor coupled to one or more of the plurality of first electrodes and the second terminal of the fifth transistor; and
an inductor having a first terminal coupled to the sixth transistor and the seventh transistor; and
a path separating unit comprising:
a first node selectively coupled to one of the charging power source and a third power source configured to supply a third voltage;
a second node coupled to a second terminal of the inductor;
first and second current paths, wherein the first current path conducts current from the first node to the second node, and the second current path conducts current from the second node to the first node,
wherein the first node is coupled to the charging power source when a voltage at the one or more of the plurality of first electrodes is substantially stable, and the first node is coupled to the third power source when the voltage at the one or more of the plurality of first electrodes is changing.
